(19) United States
(12) Patent Application Publication
(10) Pub. No.: US 2008/0162505 A1
(43) Pub. Date: Jul. 3, 2008

(54) CONTEXT BROWSER BASED NAVIGATION OF PIVOTALLY RELATED INFORMATION FOR A DOCUMENT

(76) Inventors: Charles R. Hill, Belmont, MA (US); Sandra L. Kogan, Newton, MA (US); Shi Xia Liu, Beijing (CN); Martin M. Wattenberg, Winchester, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/618,162

(22) Filed: Dec. 29, 2006

(51) Int. Cl. G06F 7/06

(52) U.S. Cl. 707/100

(57) ABSTRACT

Embodiments of the present invention address deficiencies of the art in respect to relationship-based information management and provide a novel and non-obvious method, system and computer program product for context browser based navigation of pivotally related information for a document. In one embodiment of the invention a context browser-based information management data processing system can be configured for navigation of pivotally related information for a document. The system can include an activity-centric collaboration tool configured for managing activity objects in an activity-centric collaborative computing environment. The system further can include a relationship model for selected ones of the activity objects, the model defining direct relationships between individual ones of the activity objects. Additionally, the system can include a relationship browser.

### BACKGROUND OF THE INVENTION

1. Field of the Invention

The present invention relates to a universal information client, and more particular to relationship based exploration of information in a large information space.

2. Description of the Related Art

Large sets of electronic documents can be difficult to organize manually, and even when filed, large sets of electronic documents can be difficult to navigate. Historically, the base operating system of a computing platform provided document storage and retrieval functionality including organizational operations. The core of the operating system file organizational operation is the folder or directory into which related documents can be stored. Advanced, modern forms of the operating system provide additional search and retrieval operations to facilitate the location of a desired document by name, meta-data or content.

It has long been recognized that electronic document management through base operating system functionality falls short in a multi-user environment. Consequently, enterprise document management systems permeate the information space providing advanced levels of storage and retrieval of electronic documents. Most document management systems not only structure the location of stored electronic documents, but also provide robust version control and document classification and searching features.

Relying solely upon the enterprise document management system for electronic document storage and retrieval ignores conventional reality that documents enjoy strong relationships to other document objects and non-document objects alike. In this regard, it will be recognized that oftentimes the creation and use of an electronic document relates to the completion of a task in a workflow, to a message provided by a collaborator, a scheduled event in a calendar and so forth. Yet, ordinary document management systems begin and end with the classification, storage, location and retrieval of electronic documents.

Recognizing the close relational coupling of document objects and non-document objects, bleeding edge collaborative computing tools including the Activity Explorer™ of the Lotus Workplace™ product manufactured by IBM Corporation of Armonk, N.Y. integrate document objects into a unified, activity-centric view thereby providing context to the document in terms of the larger, goal oriented picture of an activity thread. Even further, noting the arbitrary nature of barriers established between documents and other types of information, projects including the “Haystack Project” of the Massachusetts Institute of Technology investigate barrier-breaking approaches allowing users to manage information in general in ways that “make the most sense” to the end users.

The Haystack Project defines a universal information client that provides ordinary information management capabilities such as scheduling appointments, reading and creating e-mail, and organizing visual imagery, to name a few. The universal information client of the Haystack Project further provides for a lightweight structured data publishing framework through which users can generate Web pages with support for filtering, sorting and rich visualizations. Importantly, the universal information client of the Haystack Project yet further provides for relationship based exploration.

The relationship based exploration portion of the Haystack Project is configured to assist users to explore and understand portions of large information spaces by supporting knowledge of relationships between text in a document and visual objects representative of the text in the document. To date, the relationship based exploration component of the Haystack project has focused exclusively upon the software development domain in the form of the “Relo” plug-in to the Eclipse™ open development platform managed by the Eclipse Foundation, Inc. of Ottawa, Ontario.

### BRIEF SUMMARY OF THE INVENTION

Embodiments of the present invention address deficiencies of the art in respect to relationship-based information management and provide a novel and non-obvious method, system and computer program product for context browser based navigation of pivotally related information for a document. In one embodiment of the invention a context browser-based information management data processing system can be configured for navigation of pivotally related information for a document. The system can include an activity-centric collaboration tool configured for managing activity objects in an activity-centric collaborative computing environment. In this regard, activity objects can include, by way of example, activities, tasks, documents, e-mail messages, chats, instant messaging sessions, roles, users, references to workflows, to name a few. The system further can include a relationship model for selected ones of the activity objects, the model defining direct relationships between individual ones of the activity objects. Additionally, the system can include a relationship browser.

The relationship browser can include program code enabled to query the relationship model with a pivot activity object to identify a set of related activity objects for the pivot activity object. As such, a context browser can be configured to concurrently display the content of the pivot activity object and a listing of the set of related activity objects. In one aspect of the embodiment, the context browser further can be configured to concurrently highlight a portion of the set of related activity objects related according to the relationship model to a selected one of the set of related activity objects.

Notably, each related activity object in the listing can be activatable such that an activation of any of the related activity objects results in a display of the content of the activated one of the related activity objects in the context browser. Consequently, the context browser can be configured to highlight a most recently activated one of the related activity objects in the listing. The context browser also can include a graphical view of at least a portion of the relationship model. Likewise, context browser can include each of a summary view and a properties view for displaying summary content and properties, respectively, for a selected one of the related activity objects in the listing.

In another embodiment of the invention, a method for context browser based navigation of pivotally related information for a document can be provided to include pivoting a query on a relationship model of related activity objects for a specified activity object to identify a set of related activity objects for the specified activity object. The method further can include concurrently displaying in the context browser content for the specified activity object adjacent to a listing of the set of related activity objects. In the embodiment, an activity object in the listing can be selected and a new query can be pivoted on the relationship model for the selected activity object to identify a set of related activity objects for the selected one activity object.

Thereafter, common activity objects can be identified in the listing and in the identified set of related activity objects for the selected one activity object. Finally, common activity objects can be highlighted in the listing. Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a relationship model of a document for use in a context browser configured for navigation of pivotally related information for a document;

FIG. 2 is a pictorial illustration of a context browser configured for navigation of pivotally related information for a document;

FIGS. 3A and 3B, taken together, are a pictorial illustration of an activity-centric collaboration tool configured with a relationship browser for navigating pivotally related information for a selected activity object;

FIG. 4 is a schematic illustration of an information management data processing system configured for context browser based navigation of pivotally related information for a document; and,

FIG. 5 is a flow chart illustrating a process for context browser based navigation of pivotally related information for a document.

### DETAILED DESCRIPTION OF THE INVENTION

Embodiments of the present invention provide a method, system and computer program product for context browser based navigation of pivotally related information for a document. In the invention, a relationship model for activity objects in an activity-centric collaborative environment can be established, the model documenting adjacent activity objects for each activity object in an activity defined within the activity centric collaborative environment. The selection of an activity object in the environment can trigger a listing within the environment of related activity objects for the selected activity object. Each related activity object in the listing, in turn, can be rendered activatable such that the activation of a related activity object can result in a display of the related activity object and a re-listing of different related activity objects for the activated activity object. Consequently, ready access to contextually relevant activity objects for selected activity objects can be provided.

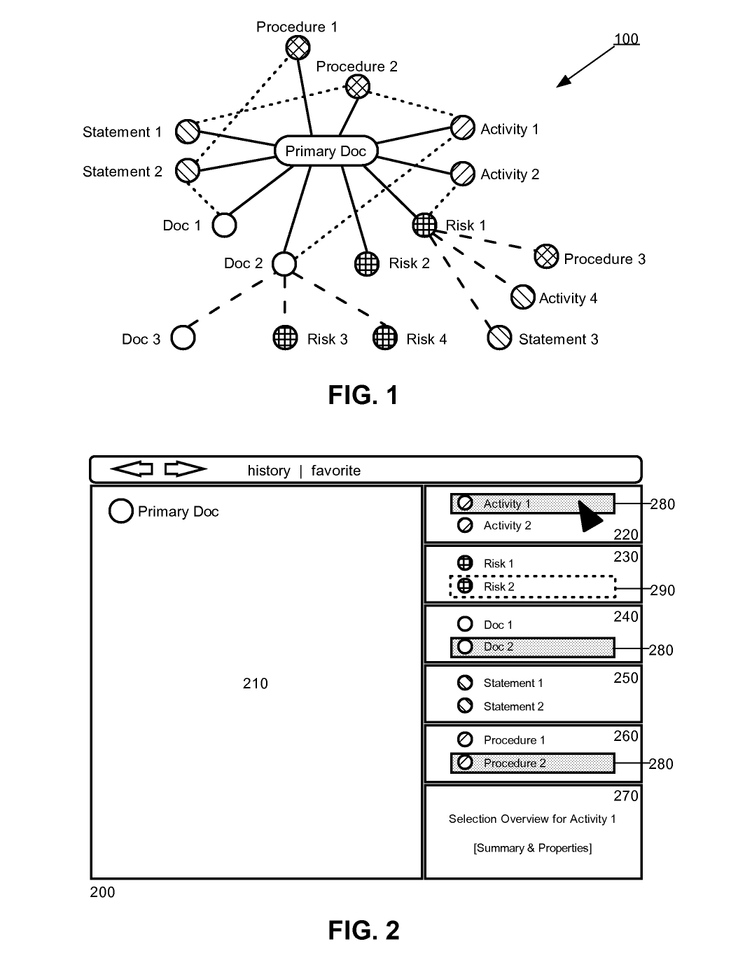

In illustration, FIG. 1 is a pictorial illustration of a relationship model of a document for use in a context browser configured for navigation of pivotally related information for a document. The relationship model 100 can include a multiplicity of nodes in an activity, where each of node corresponds to a different activity object, for instance a task, a document, a message, and the like. Each node in the relationship model 100 can be associated with one or more other nodes such that computing a pivot for the relationship model on any given node will provide a set of related nodes. Each node in the set, in turn can be viewed as a pivot resulting in a set of related nodes and so forth. It will be recognized by the skilled artisan that the relationship model 100 can be defined within a flat file or relational database, for example, and can be rendered visually as well as shown in FIG. 1.

Turning now to FIG. 2, a pictorial illustration of a context browser configured for navigation of pivotally related information for a document is shown. The context browser 200 can provide an object view 210 for a selected activity object in an activity. Those related activity objects 220, 230, 240, 250, 260 that are directly associated with the selected activity object in the object view 210 can be listed separately in the context browser 200 according to activity object type. Each of the related activity objects 220, 230, 240, 250, 260 further can be enabled for selection and activation. Responsive to the activation of any of the related activity objects 220, 230, 240, 250, 260, the activated one of the related activity objects 220, 230, 240, 250, 260 can be displayed in the object view 210 and a new listing of related activity objects 220, 230, 240, 250, 260 can be provided for activated one of the related activity objects 220, 230, 240, 250, 260.

Notably, a pivot selection 280 can be provided for the related activity objects 220, 230, 240, 250, 260. In this regard, responsive to the selection of one of the related activity objects 220, 230, 240, 250, 260, the relationship model can be queried on pivot for the selected one of the related activity objects 220, 230, 240, 250, 260 to identify a set of related objects and those of the identified set of related objects that already are included as part of the related activity objects 220, 230, 240, 250, 260 can be highlighted or otherwise distinguished as shown in FIG. 2. As well, a last activated related activity object 290 further can be highlighted, outlined or otherwise distinguished. Finally, a summary view 270 can be provided for a selected one of the related activity objects 220, 230, 240, 250, 260 to provide a quick view of the summary content and properties of a selected one of the related activity objects 220, 230, 240, 250, 260.

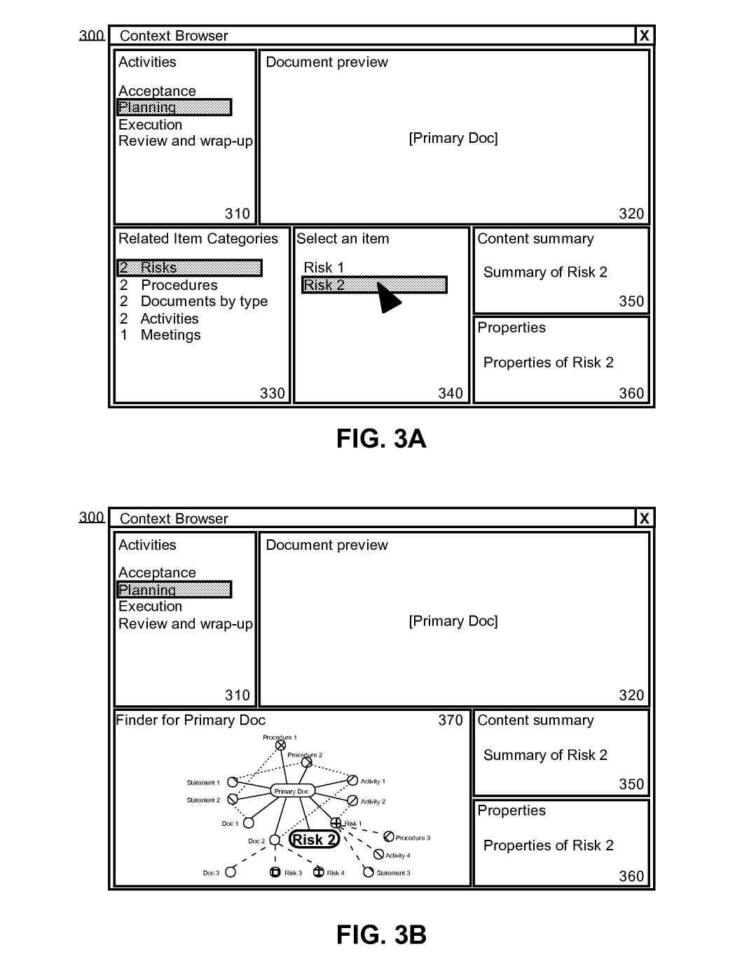

The context browser of FIG. 2 can be deployed as part of the user interface for an activity-centric collaboration tool. For instance, FIGS. 3A and 3B, taken together, are a pictorial illustration of an activity-centric collaboration tool configured with a relationship browser for navigating pivotally related information for a selected activity object. As shown in FIG. 3A, a context browser 300 can provide an activities selector 310 listing a set of activities in an activity-centric collaboration tool. A document preview 320 further can be provided in which a selected document for a selected activity can be displayed.

A related items category view 330 can be provided in the context browser 300. The related items category view 330 can include a listing of categories for different related objects for the document in the document preview 320. The listing of categories also can indicate a number of related objects identified for each of the categories. An item selection view 340 yet further can be provided and can include a listing of related objects corresponding to a selection in the related items category view 330. Finally, each of a content summary view 350 and a properties view 360 can be provided for displaying respectively a content summary and properties for a selected related object in the item selection view 340.

Each item in the item selection view 340 can be configured for activation. As such, upon activation of a selected item in the item selection view 340, the content selected item can be rendered in the document preview 320 and a new set of related objects can be computed for the selected item. The new set of related objects can be categorized and the related items categories view 330 can be updated accordingly as can the item selection view 340. Notably, a visual finder 370 further can be provided as shown in FIG. 3B to provide a graphical means for navigating the related objects in lieu of the combined operation of the related items categories view 330 and the item selection view 340. Additionally, a computation of the strength of a relationship between the related objects and a selected item in the selection view 340 can be provided (not shown). The computation of the strength of the relationship can be manually pre-specified, or dynamically computed according to any user provided algorithm.

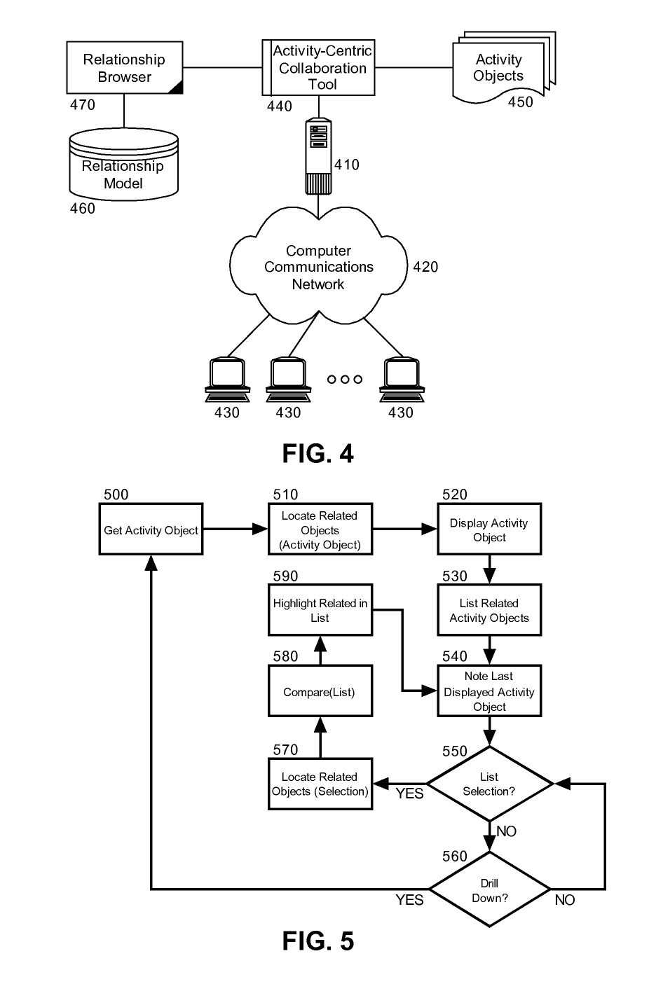

Turning now to FIG. 4, an information management data processing system is shown to be configured for context browser based navigation of pivotally related information for a document. The system can include a host computing platform 410 configured to support the operation of an activity-centric collaboration tool 440 enabled to manage one or more activity objects 450 in respect to the definition, maintenance and completion of one or more collaborative activities. To that end, the host computing platform 410 further can be configured for communicative coupling to one or more client computing devices 430 over computer communications network 420 such that collaborators can access the activity objects 450 of the activity-centric collaboration tool 440 remotely.

The activity-centric collaboration tool 440 can be coupled to a relationship browser 470. The relationship browser 470 can include program code enabled to query a relationship model 460 defining nearest neighbor relationships between the different activity objects 450. In this regard, the program code can be enabled to repeatedly apply different pivots on different specified ones of the activity objects 450 to produce different sets of related ones of the activity objects 450. Each resulting set of the related ones of the activity objects 450 can be displayed concurrently with the display of a corresponding one of the activity objects 450 providing the pivot. In this way, contextually pertinent links to related ones of the activity objects 450 can be readily accessed when viewing a selected one of the activity objects 450. Moreover, in as much as the related one of the activity objects 450 can include collaborators associated with a specified one of the activity objects 450, the relationship browser 470 can facilitate the end user in readily accessing the associated collaborators, for example, by initiating a chat with the associated collaborators for a selected document.

In illustration, FIG. 5 is a flow chart illustrating a process for context browser based navigation of pivotally related information for a document. Beginning in block 500, an activity object for an activity can be selected for display in a view for the context browser. In block 510, the relationship model for the activity can be queried to locate related objects for the selected activity object. Finally, in block 520 the activity object can be displayed as can an activated listing of the related objects in block 530. Optionally, in block 540 a last activated activity object, if present in the listing of related objects can be highlighted for reference by the viewer.

In decision block 550, it can be determined whether or not a related object in the listing has been selected. If so, the process can proceed through block 570. In contrast, if it is determined that a related object in the listing has not been selected, in decision block 560 it further can be determined whether or not a related object in the listing has been activated. If so, in block 500, the activity object referenced by the related object can be selected for display in the context browser and the process can repeat for the activity object as a pivot point when querying the relationship model.

Returning to decision block 550, if it is determined that a related object in the listing has been selected, in block 570 the relationship model can be queried with the selected related object as a pivot point in order to generate a set of activity objects related to the selected related object. Thereafter, in block 580, the related objects already in the listing can be compared to the generated set to identify related objects already displayed. Consequently, in block 590, those identified related objects can be highlighted in order to demonstrate the related nature of those related objects to the selected related object in the listing.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A context browser-based information management data processing system configured for navigation of pivotally related information for a document, the system comprising:
an activity-centric collaboration tool configured for managing a plurality of activity objects in an activity-centric collaborative computing environment;
a relationship model for selected ones of the activity objects, the model defining direct relationships between individual ones of the activity objects;
a relationship browser comprising program code enabled to query the relationship model with a pivot activity object to identify a set of related activity objects for the pivot activity object; and,
a context browser configured to concurrently display the content of the pivot activity object and a listing of the set of related activity objects.

2. The system of claim 1, wherein the context browser is further configured to concurrently highlight a portion of the set of related activity objects related according to the relationship model to a selected one of the set of related activity objects.

3. The system of claim 1, wherein each related activity object in the listing is activatable such that an activation of any of the related activity objects results in a display of the content of the activated one of the related activity objects in the context browser.

4. The system of claim 3, wherein the context browser is further configured to highlight a most recently activated one of the related activity objects in the listing.

5. The system of claim 1, wherein the context browser further comprises a graphical view of at least a portion of the relationship model.

6. The system of claim 1, wherein the context browser further comprises a summary view for displaying summary content for a selected one of the related activity objects in the listing.

7. The system of claim 1, wherein the context browser further comprises a properties view for displaying properties for a selected one of the related activity objects in the listing.

8. A method for context browser based navigation of pivotally related information for a document, the method comprising:
pivoting a query on a relationship model of related activity objects for a specified activity object to identify a set of related activity objects for the specified activity object; and,
concurrently displaying in the context browser, content for the specified activity object adjacent to a listing of the set of related activity objects.

9. The method of claim 8, further comprising:
selecting one activity object in the listing;
pivoting a new query on the relationship model for the selected one activity object to identify a set of related activity objects for the selected one activity object;
identifying common activity objects in the listing and the identified set of related activity objects for the selected one activity object; and,
highlighting common activity objects in the listing.

10. The method of claim 8, further comprising:
activating one activity object in the listing;
pivoting a new query on the relationship model for the activated one activity object to identify a set of related activity objects for the activated one activity object; and,
replacing the content for the specified activity object in the context browser with content for the activated one activity object while replacing activity objects in the listing with the identified set of related activity objects for the activated one activity object.

11. The method of claim 8, further comprising:
generating a summary of a selected one of the activity objects in the listing; and,
concurrently displaying the summary in the context browser along with the content for the specified activity and the adjacent listing of the set of related activity objects.

12. The method of claim 8, further comprising
generating a graphical view of the relationship model; and,
concurrently displaying the graphical view of the relationship model in the context browser along with the content for the specified activity and the adjacent listing of the set of related activity objects.

13. A computer program product comprising a computer usable medium having computer usable program code for context browser based navigation of pivotally related information for a document, the computer program product including:
computer usable program code for pivoting a query on a relationship model of related activity objects for a specified activity object to identify a set of related activity objects for the specified activity object; and,
computer usable program code for concurrently displaying in the context browser, content for the specified activity object adjacent to a listing of the set of related activity objects.

14. The computer program product of claim 13, further comprising:
computer usable program code for selecting one activity object in the listing;
computer usable program code for pivoting a new query on the relationship model for the selected one activity object to identify a set of related activity objects for the selected one activity object;
computer usable program code for identifying common activity objects in the listing and the identified set of related activity objects for the selected one activity object; and,
computer usable program code for highlighting common activity objects in the listing.

15. The computer program product of claim 13, further comprising:
computer usable program code for activating one activity object in the listing;
computer usable program code for pivoting a new query on the relationship model for the activated one activity object to identify a set of related activity objects for the activated one activity object; and,
computer usable program code for replacing the content for the specified activity object in the context browser with content for the activated one activity object while replacing activity objects in the listing with the identified set of related activity objects for the activated one activity object.

16. The computer program product of claim 13, further comprising:
computer usable program code for generating a summary of a selected one of the activity objects in the listing; and,
computer usable program code for concurrently displaying the summary in the context browser along with the content for the specified activity and the adjacent listing of the set of related activity objects.

17. The computer program product of claim 13, further comprising
computer usable program code for generating a graphical view of the relationship model; and,
computer usable program code for concurrently displaying the graphical view of the relationship model in the context browser along with the content for the specified activity and the adjacent listing of the set of related activity objects.
